(19) United States
(12) Patent Application Publication
(10) Pub. No.: US 2007/0046251 A1
(43) Pub. Date: Mar. 1, 2007

(54) Mini-generator system in rechargeable battery

(76) Inventor: Richard Chi-Hsueh, Cary, NC (US)

Correspondence Address: RICHARD HSU, 102 WHISPERWOOD RD, CARY, NC, 27511, US

(21) Appl. No.: 11/508,454

(22) Filed: Aug. 23, 2006

Related U.S. Application Data
(60) Provisional application No. 60/711,465, filed on Aug. 26, 2005.

(51) Int. Cl. H02J 7/00

(52) U.S. Cl. 320/101

(57) ABSTRACT

A mechanical device that is constructed within rechargeable battery, upon kinetics force, the gears of the device drives set of highly magnetic flywheels. The magnetic field created by the flywheels is transformed to electrical current to supply the rechargeable battery. The device can be made to any size to accompany the demand of the consumers. The mini-generator system would be ideal for portable electronics.

This invention is base on a concept of placing a mini-generator system in re-chargeable battery that when experiencing any kind of motion will trigger the self-charging process. This self-charging battery is ideal for portable electronics that will be carried by consumers on a regular basis, such as cell phones, laptop computers, and MP3 players. When the battery is experiencing motions of any kind, it is able to convert motion into energy and stores the energy in the battery cell. Since the battery is designed for portable electronics, they will be carried around, thus always charging themselves.

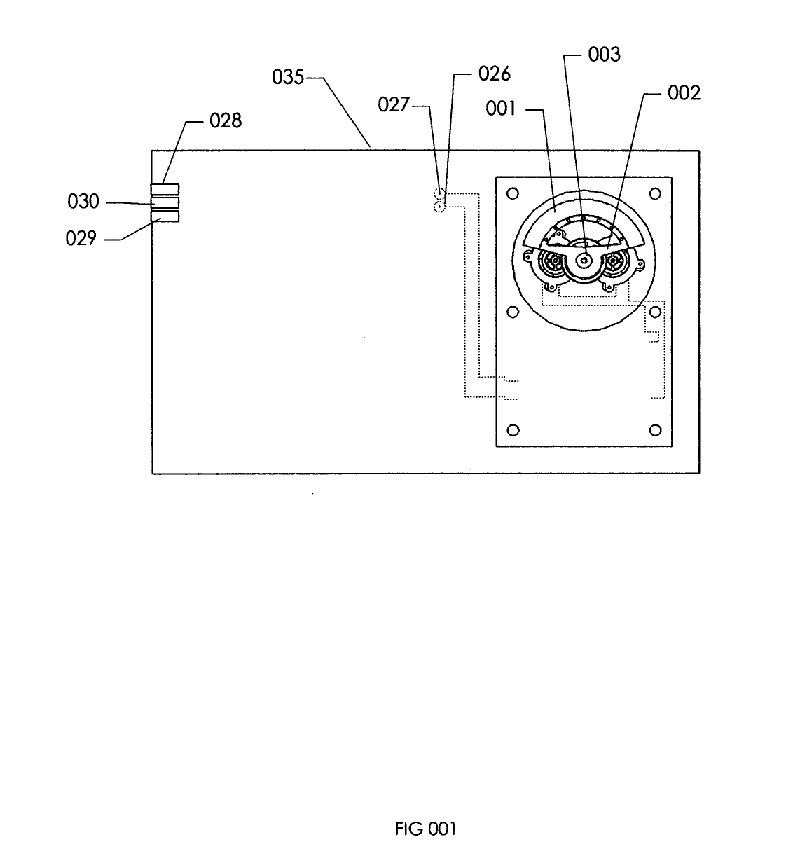

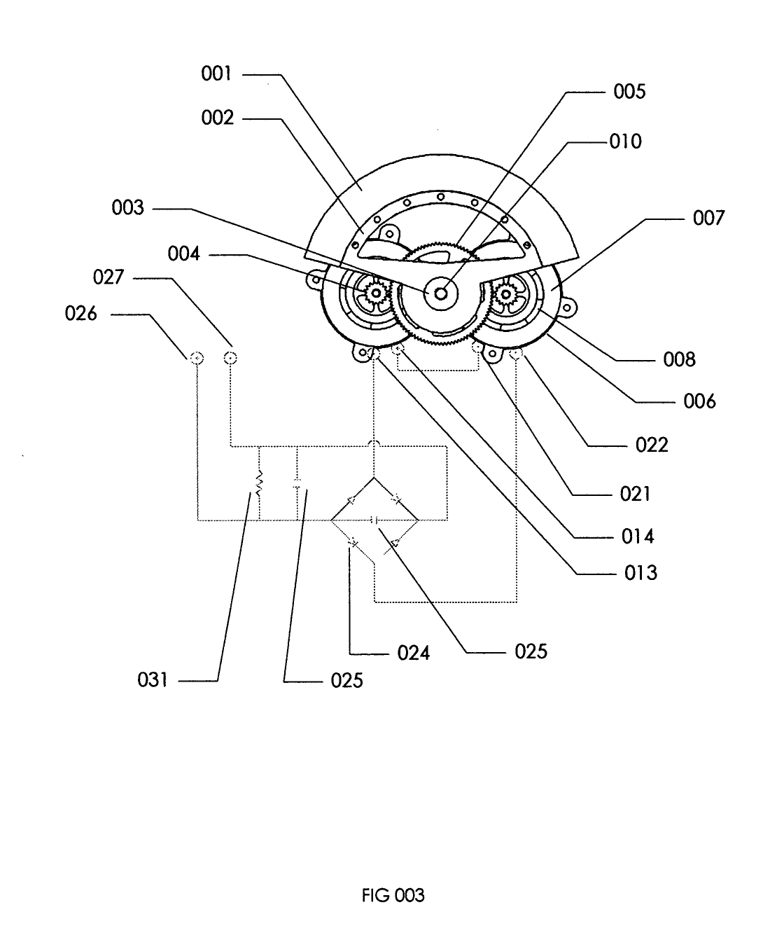

Shown in FIG. 003 the impact from the motion transfers to the pendulum 001 in the mini-generator will start a continuous swing action. The gear 005 then transfer the energy from the pendulum to the two generator gears 004 that drive the multi-polar magnet rotation plates 008. When the magnet plates spin, the magnetic field then is cut by the silicon steel lamination 006 the wires 007 in the generators induct the electricity. Through the wires 013 and 014 to diode bridge 024 and 025 that transform the AC voltage into DC voltage. Then the voltage is transmitted to the rechargeable battery positive terminal 028 and negative terminal 029 (shown on FIG. 001. FIG. 001 is a complete assembly of the battery).

The rechargeable battery cell has to be designed so that the mini-generator can be placed within the battery cell (see FIG. 001). And the generator parts will be made from stainless steel, to reduce any magnetic interference. The most important component of this invention is the mini generator system, which allows the self-charging process when experiencing motion.

This invention technique can be applied on any personal electronics that can be carried around, such as laptops, mobile phones, digital cameras, and MP3 players. This will solve the problems of AC charging and to be used at anywhere, because when consumers are using these portable electronics, the electronics are charging themselves while they are experiencing any movement.

FIG. 001—Unit of the mechanical generator placed in a battery cell.

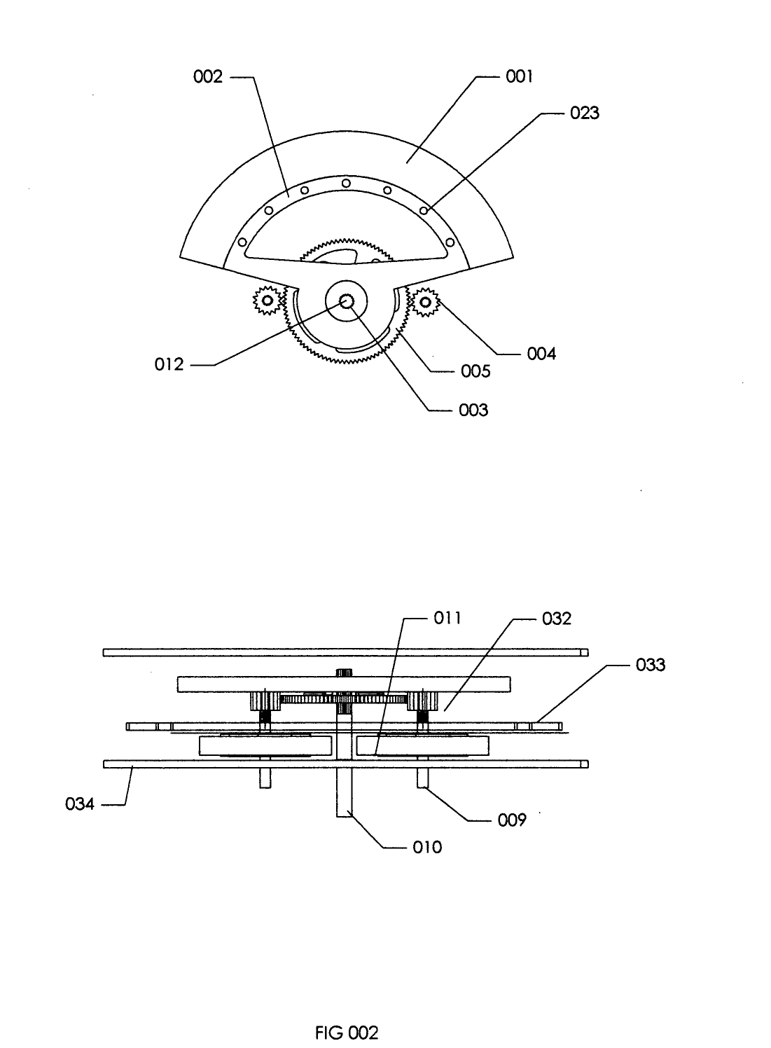

FIG. 002—A detailed drawing of the pendulum and side view of the generator.

FIG. 003—The pendulum swings when experiencing movements, it also drives the generator gears that produce the current.

FIG. 003—Detailed diagram showing the relation between the generator and the circuit.

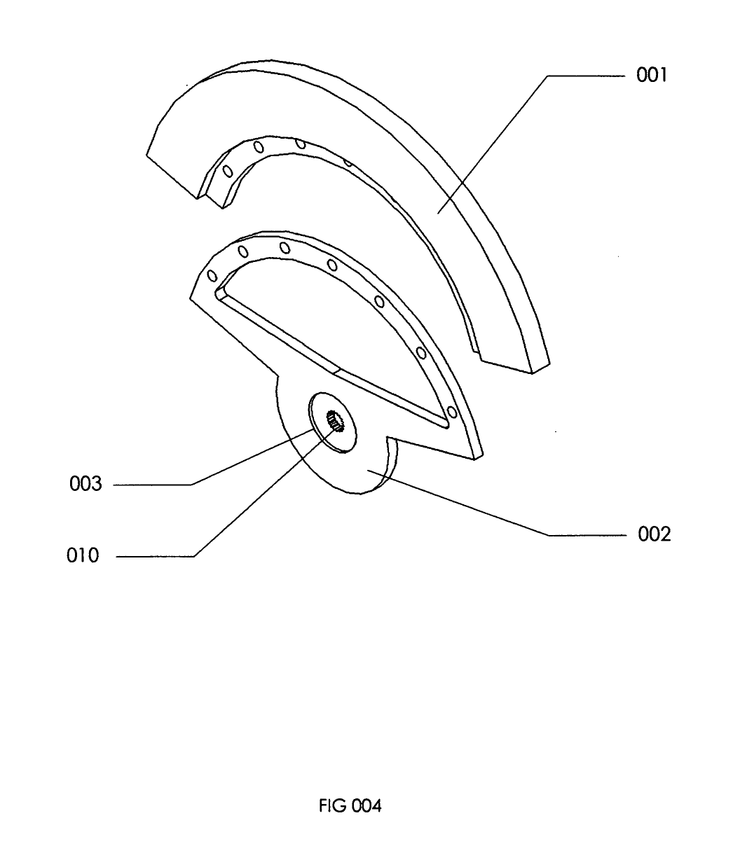

FIG. 004—How the pendulum is assembled.

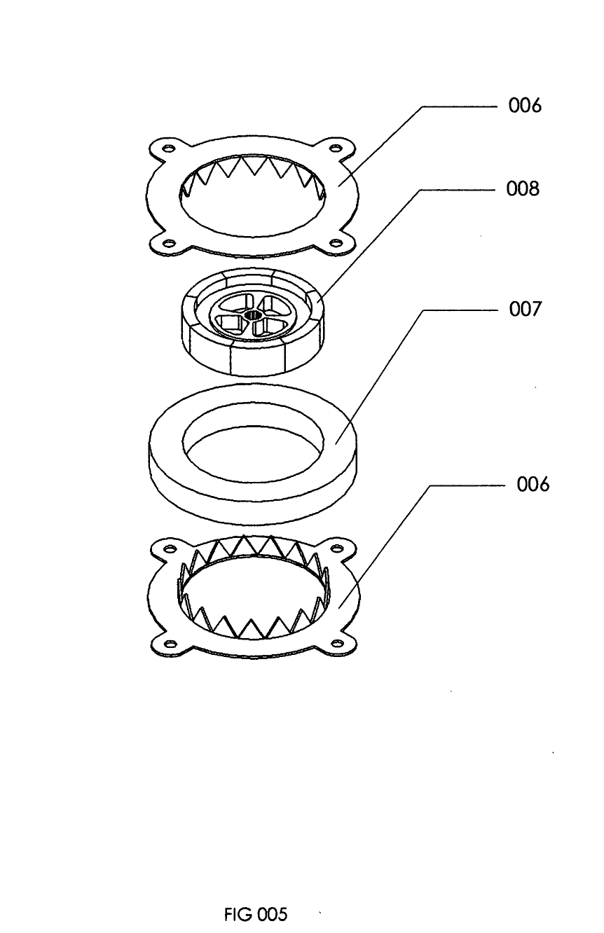

FIG. 005—The general assemble of the magnetic flywheel and the wires.

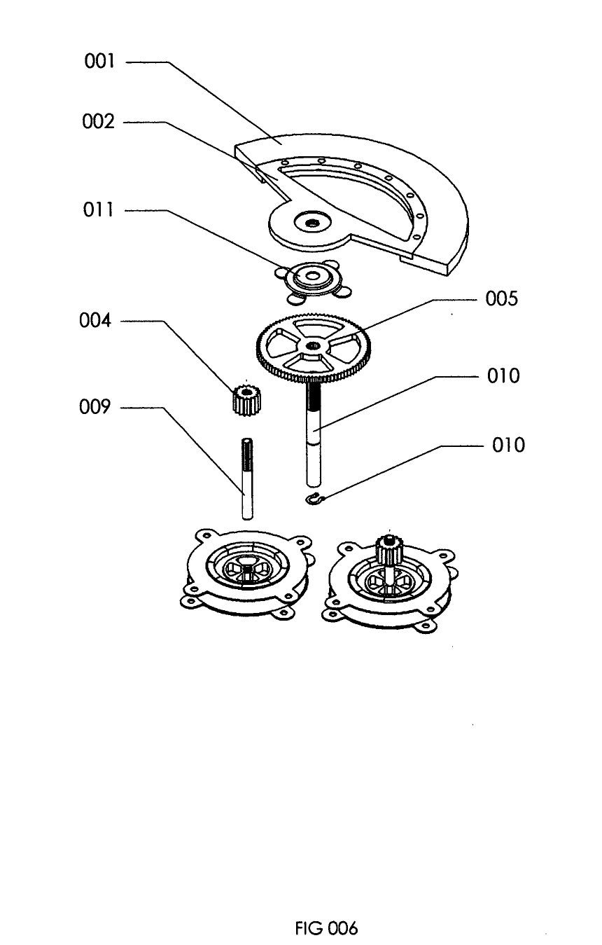

FIG. 006—General assembly of the generator.

001 Generator pendulum
002 Generator pendulum gear
003 Generator pendulum hole
004 Generator gear
005 Generator driving gear
006 Support for the generator wires
007 Section view of the generator wires
008 Multi-polar magnets
009 Shaft bearing for the magnets
010 Support for the pendulum and the pendulum gear
011 Spring ring
012 Screws for the pendulum
013 Output of the sensor wire
014 Output of the sensor wire
015 Generator supporting shaft
016 Generator supporting shaft screw
017 Pendulum shaft
018 Generator shaft
019 Screw
020 Screw
021 Output sensor wire
022 Output sensor wire
023 Screws for securing the pendulum onto the pendulum gear
024 Current rectifiers, diode bridge
025 Capacitor
026 DC output
027 DC output
028 Battery positive terminal
029 Battery negative terminal
030 Battery connector
031 Resistor
032 Generator top board
033 Sensor board
034 Generator bottom board
035 Battery

1. A small mechanical device about one-third size of t rechargeable battery, contains a pendulum that will swing continuously when acted on by outside force, in which drives the gears activate the magnetic flywheels at a high speed. The magnetic field is then transformed into electrical current that supplies the battery.
